(19) United States
(12) Patent Application Publication
(10) Pub. No.: US 2025/0355971 A1
(43) Pub. Date: Nov. 20, 2025

(54) ADAPTIVE BACKTRACKING DEPTH LIMIT FOR NON-DETERMINISTIC FINITE AUTOMATON IMPLEMENTATIONS

(71) Applicant: Microsoft Technology Licensing, LLC, Redmond, WA (US)

(72) Inventors: Jitendra LULLA, Bangalore (IN); Edward Leo WIMMERS, San Jose, CA (US); Renat IDRISOV, Menlo Park, CA (US); Ashwin Srinath SUBRAMANIAN, San Jose, CA (US); Ravi Mohan HOSABETTU, San Roman, CA (US)

(21) Appl. No.: 18/667,376

(22) Filed: May 17, 2024

(51) Int. Cl. G06F 18/22

(52) U.S. Cl. CPC G06F 18/22

(57) ABSTRACT

Systems and methods for adaptive backtracking depth limit for non-deterministic finite automaton implementations are provided. A method includes, as part of a match attempt between a regular expression (regex) pattern and a payload, a non-deterministic finite automaton (NFA) instance executing instructions for an NFA graph having a plurality of nodes linked via arcs indicative of transitions among states of the NFA instance. The method further includes during execution of the instructions for the NFA graph, using a backtrack-depth counter counting a number of times a current state of the NFA graph has been previously visited during the match attempt between the regex pattern and the payload. The method further includes, upon the backtrack-depth counter for the NFA instance reaching or exceeding an adaptive backtracking depth limit for the NFA instance, terminating the match attempt between the regex pattern and the payload.

### BACKGROUND

Regular expressions are used for matching input strings with patterns, each of which can be a word, a phrase, or any set of characters, including symbols. A regular expression can also include metadata and characters that provide rules for searching an input string for a match to a regular expression. Regular expression compilers can be used to generate a binary output that encodes the rules for processing input strings in terms of finite state machine graphs. The graphs and related binaries output by the regular expression compiler can be processed by regular expression engines. The regular expression engines for processing regular expressions can include both deterministic finite automatons (DFAs) and non-deterministic finite automatons (NFAs). While DFAs are more suited for processing single path regular expressions, the NFAs can be used to process instructions that can handle forward matching, reverse matching, looping, or other types of paths.

Conventional NFA implementations are vulnerable to service outages due to unsafe patterns or malicious payloads being matched against those patterns. Accordingly, there is a need for improvements to the NFA implementations to alleviate such issues.

### SUMMARY

In one example, the present disclosure relates to a method including, as part of a match attempt between a regular expression (regex) pattern and a payload, a non-deterministic finite automaton (NFA) instance executing instructions for an NFA graph having a plurality of nodes linked via arcs indicative of transitions among states of the NFA instance. The method may further include during execution of the instructions for the NFA graph, using a backtrack-depth counter counting a number of times a current state of the NFA graph has been previously visited during the match attempt between the regex pattern and the payload. The method may further include, upon the backtrack-depth counter for the NFA instance reaching or exceeding an adaptive backtracking depth limit for the NFA instance, terminating the match attempt between the regex pattern and the payload.

In another example, the present disclosure relates to a method including, as part of a match attempt between a regular expression (regex) pattern and a payload, a non-deterministic finite automaton (NFA) instance executing instructions for an NFA graph having a plurality of nodes linked via arcs indicative of transitions among states of the NFA instance. The method may further include during execution of the instructions for the NFA graph, using a backtrack-depth counter counting a number of times a current state of the NFA graph has been previously visited during the match attempt between the regex pattern and the payload.

The method may further include, upon the backtrack-depth counter for the NFA instance reaching or exceeding an adaptive backtracking depth limit for the NFA instance, terminating the match attempt between the regex pattern and the payload. The method may further include dynamically adjusting the adaptive backtracking depth limit for the NFA instance depending on an input size of the payload.

In a yet another example, the present disclosure relates to a method including deploying a regular expression (regex) accelerator to find matches between respective regex patterns and respective payloads associated with a storage or a network appliance, where the regex accelerator comprises non-deterministic finite automaton (NFA) instances. The method may further include as part of a first match attempt between a first regex pattern and a first payload, a first non-deterministic finite automaton (NFA) instance executing instructions for a first NFA graph having a first plurality of nodes linked via arcs indicative of transitions among states of the first NFA instance. The method may further include as part of a second match attempt between a second regex pattern and a second payload, a second non-deterministic finite automaton (NFA) instance executing instructions for a second NFA graph having a second plurality of nodes linked via arcs indicative of transitions among states of the second NFA instance.

The method may further include upon a first backtrack-depth counter for the first NFA instance reaching or exceeding a first adaptive backtracking depth limit for the first NFA instance, terminating the first match attempt between the first regex pattern and the first payload. The method may further include upon a second backtrack-depth counter for the second NFA instance reaching or exceeding a second adaptive backtracking depth limit for the second NFA instance, different form the first adaptive backtracking depth limit, terminating the second match attempt between the second regex pattern and the second payload.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The present disclosure is illustrated by way of example and is not limited by the accompanying figures, in which like references indicate similar elements. Elements in the figures are illustrated for simplicity and clarity and have not necessarily been drawn to scale.

FIG. 1 is a block diagram of a system environment for implementing an adaptive backtracking depth limit for non-deterministic finite automatons (NFAs) in accordance with one example;

FIG. 2 is a block diagram of a system for generating an initial value of an adaptive backtracking depth limit for a non-deterministic finite automaton (NFA) in accordance with one example;

FIG. 3 is a block diagram of a regex system environment with an adaptive backtracking depth limit for non-deterministic finite automatons (NFAs) in accordance with one example;

FIG. 4 is a block diagram of another regex system environment with an adaptive backtracking depth limit for non-deterministic finite automatons (NFAs) in accordance with one example;

FIG. 5 shows a memory associated with a regular expression accelerator for implementing an adaptive backtracking depth limit for non-deterministic finite automatons (NFAs) in accordance with one example;

FIG. 6 shows a regular expression accelerator for implementing an adaptive backtracking depth limit for non-deterministic finite automatons (NFAs) in accordance with one example;

FIG. 7 is a flow diagram of a method for implementing an adaptive backtracking depth limit for non-deterministic finite automatons (NFAs) in accordance with one example; and

FIG. 8 is a flow diagram of another method for implementing an adaptive backtracking depth limit for non-deterministic finite automatons (NFAs) in accordance with one example.

### DETAILED DESCRIPTION

Examples disclosed in the present disclosure relate to methods and systems for implementing an adaptive backtracking depth limit for non-deterministic finite automatons (NFAs). As noted earlier, regular expressions are used for matching input strings with patterns, each of which can be a word, a phrase, or any set of characters, including symbols. A regular expression can also include metadata and characters that provide rules for searching an input string for a match to a regular expression. Regular expression compilers can be used to generate a binary output that encodes the rules for processing input strings in terms of finite state machine graphs. The graphs and related binaries output by the regular expression compiler can be processed by regular expression engines. The regular expression engines for processing regular expressions can include both deterministic finite automatons (DFAs) and non-deterministic finite automatons (NFAs). While DFAs are more suited for processing single path regular expressions, the NFAs can be used to process instructions that can handle forward matching, reverse matching, looping, or other types of paths.

Backtracking during regular expression processing occurs when a regular expression pattern contains instructions that allow the NFA to return to an earlier saved state and continue matching from there. This process of returning to a previously saved state to find a match is one example of backtracking. Conventional NFA implementations that support backtracking are vulnerable to service outages due to unsafe patterns or malicious payloads being matched against those patterns. The examples described herein address such backtracking-related issues by implementing an adaptive backtracking depth limit for the NFAs.

The input strings being searched by a regular expression engine can include strings related to networking traffic, intrusion detection (or other security-related data), storage data, or other types of data and/or instructions. As an example, networking traffic can be searched for input strings that may help a security system (e.g., a firewall) deny or permit actions. Similarly, storage data can be searched for input strings to detect any malicious code or data. Hardware accelerators can be used to perform such specialized tasks, which can process the work offloaded by the central processing units (CPUs) or the graphics processing units (GPUs). The specialized tasks can relate to the searching for certain input strings (also referred to as payload) in the context of any of networking, storage, security, or virtualization aspects.

One class of hardware accelerators for processing regular expressions can include deterministic finite automatons (DFAs) and non-deterministic finite automatons (NFAs). A hardware accelerator including such DFAs and NFAs may be implemented using any of Application Specific Integrated Circuits (ASICs), Field Programmable Gate Arrays (FPGAs), Erasable and/or Complex programmable logic devices (PLDs), Programmable Array Logic (PAL) devices, or Generic Array Logic (GAL) devices. Desired regular expression processing functionality can be implemented to support any service that can be offered via a combination of computing, networking, and storage resources, such as via a data center or other infrastructure for delivering a service.

The regex accelerators can also be implemented in cloud computing environments. Cloud computing may refer to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly. A cloud computing model can be composed of various characteristics such as, for example, on-demand self-service, broad network access, resource pooling, rapid elasticity, measured service, and so forth. A cloud computing model may be used to expose various service models, such as, for example, Hardware as a Service (“HaaS”), Software as a Service (“SaaS”), Platform as a Service (“PaaS”), and Infrastructure as a Service (“IaaS”). A cloud computing model can also be deployed using different deployment models such as private cloud, community cloud, public cloud, hybrid cloud, and so forth.

A regular expression can include various characters and symbols, including the ones shown in Table 1 below.

TABLE 1
a. A character to be matched. (e.g., “a”, “b”)
b. Assertions about the current position in the payload. An assertion
can be a special constraint (e.g., the beginning of a word or the
beginning of a line). An assertion can also be a token in which case
the parenthesis are supplemented with a matching direction and
optional negation of the match.
c. Repetition of a token with a lower_bound >= 0 and an
upper_bound >= lower_bound. Repetition can be lazy, eager,
or possessive. The upper bound can be set to a special value which
represents infinity. (e.g., “a”{0, 8}, “a”{1, inf}, “a”{5, 5}).
d. Sequence of tokens to be matched. (e.g., “a” “b” “c”).
e. Alternation of Tokens (match A or B). (e.g., (“a” or “b” or “c”)).
f. Capture group. Capture group is a token in which a matched
payload string is stored for further matching once the token has
been matched. (e.g., Capture is a token in parenthesis).
g. Backreference is a reference to a capture group.
(e.g., (“a” or “b”)\\1).

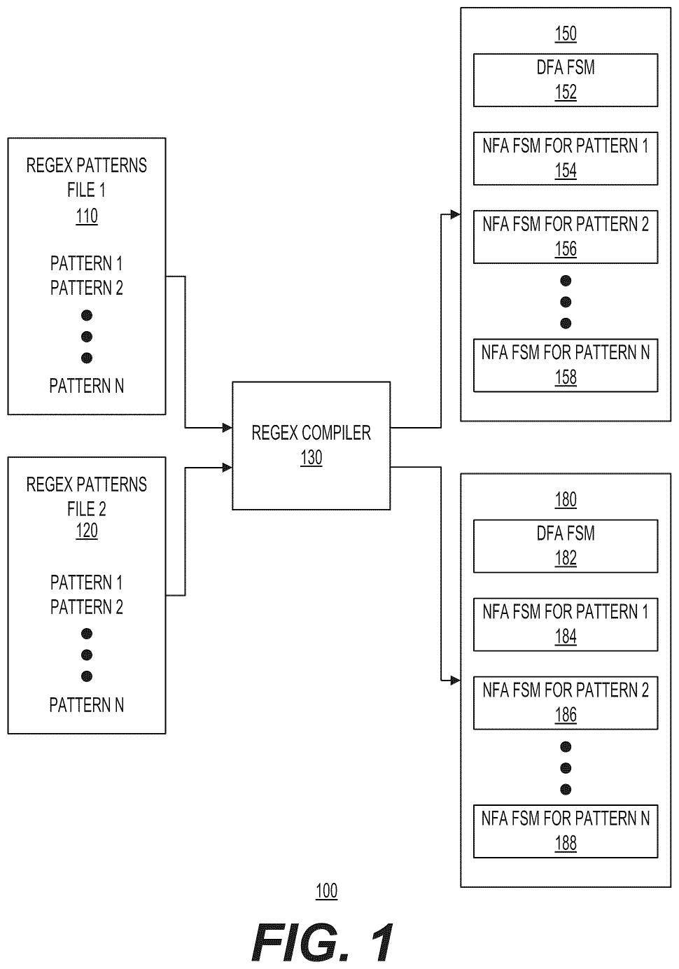

FIG. 1 is a block diagram of a system environment 100 for implementing an adaptive backtracking depth limit for non-deterministic finite automatons (NFAs) in accordance with one example. In this example, the system environment 100 includes a regular expression (regex) compiler 130 to generate bytecodes (or another form of binary for execution by a hardware accelerator or another processor). Input for the regex compiler 130 includes regular expressions to be processed (e.g., regex patterns file 1 110 and regex patterns file 2 120). The regular expressions may be received via an interface (not shown) allowing processing cores associated with CPUs or other processors to offload certain tasks. Regular expressions may include regex patterns formed using various characters and symbols, such as the examples shown in table 1. The output from the regex compiler 130 includes output binary produced as a combination of the DFA graphs, NFA graphs, and the software data.

Each NFA graph includes a set of nodes (each node in the graphs represents a state) linked by arcs, where each arc represents a transition between two states based on specific criteria for the arc. Each node of an NFA graph may link to itself and/or to the other nodes within the NFA graph. In some examples, transitions between states may consume a symbol of a payload. In other examples, transitions between states may not consume any symbol of the payload. Each DFA graph has a finite set of states and an arc for each symbol to another (or possibly the same) state. Unlike the NFA, the DFA can transition at a time from only one state to another state (or itself). During each transition, a symbol from the payload is consumed and the appropriate arc is followed.

With continued reference to FIG. 1, the regular expression pattern files received by regex compiler 120 are processed to build a first group of FSMs 150 for processing regex patterns file 1 110 and a second group of FSMs 180 for processing regex patterns file 2 120. The first group of FSMs 150 includes a DFA finite-state machine (FSM) 152 and multiple NFA FSMs (e.g., NFA FSM for pattern 1 154, NFA FSM for pattern 2 156, and NFA FSM for pattern N 158. The second group of FSMs 180 includes a DFA FSM 182 and multiple NFA FSMs (e.g., NFA FSM for pattern 1 184, NFA FSM for pattern 2 186, and NFA FSM for pattern N 188). These FSMs can execute bytecode (or other forms of binary code) that can be output to a memory system for further processing by the relevant NFA and DFA implementations. Although FIG. 1 shows a certain number of patterns being processed as part of system environment 100, this environment may include additional or fewer patterns that are being processed. In addition, although FIG. 1 shows two groups of FSMs 150 and 180, the output from regex compiler 130 may include additional FSMs and other related binaries.

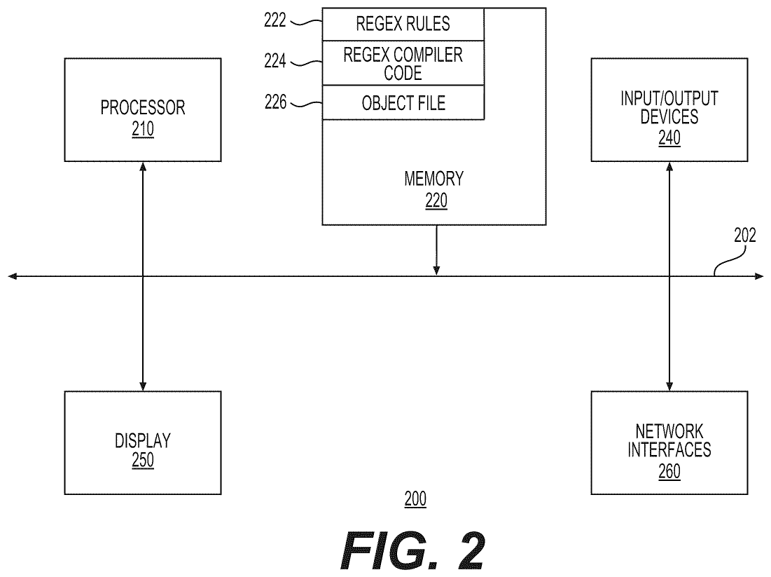

FIG. 2 is a block diagram of a system 200 for implementing an adaptive backtracking depth limit for a non-deterministic finite automaton (NFA) in accordance with one example. System 200 includes a processor 210, a memory 220, input/output devices 240, display 250, and network interfaces 260 interconnected via bus system 202. Memory 220 includes regex rules 222, regex compiler code 224, and object file 226. Regex rules 222 may include the various regex pattern files and other rules for processing input strings. Regex compiler code 224 may include code corresponding to the regex compiler 130 of FIG. 1. Object file 226 may include the output generated by the execution of the regex compiler code 224 by processor 210. Although FIG. 2 shows a certain number of components of system 200 arranged in a certain way, additional or fewer components arranged differently may also be used. In addition, although memory 220 shows certain blocks of code, the functionality provided by this code may be combined or distributed. In addition, the various blocks of code may be stored in non-transitory computer-readable media, such as non-volatile media and/or volatile media. Non-volatile media include, for example, a hard disk, a solid state drive, a magnetic disk or tape, an optical disk or tape, a flash memory, an EPROM, NVRAM, PRAM, or other such media, or networked versions of such media. Volatile media include, for example, dynamic memory, such as, DRAM, SRAM, a cache, or other such media. In addition, as described herein the term code is not limited to “code” expressed in a particular encoding or expression via a particular syntax. As an example, code may include graphs or other forms of encodings.

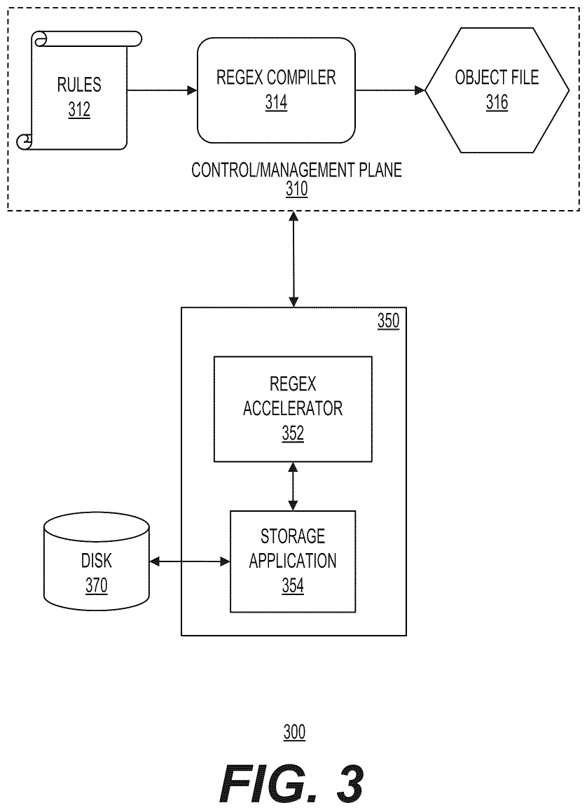

FIG. 3 is a block diagram of a regex system environment 300 with an adaptive backtracking depth limit for non-deterministic finite automatons (NFAs). Regex system environment 300 shows a control/management plane 310 coupled to a storage appliance 350, which is further coupled to a storage disk 370. Regex system environment 300 includes a regex compiler 314 (similar to regex compiler 130 of FIG. 1), which takes rules 312 as input and generates an object file 316 as an output. Object file 316 is in a form (e.g., a binary form) that can be processed by regex accelerator 352. Regex accelerator 352 with an adaptive background depth limit is configured to process NFA graphs, DFA graphs, and other software artifacts generated by regex compiler 314. Regex accelerator 352 is coupled to a storage application 354, which in turn can store or retrieve data from storage disk 370.

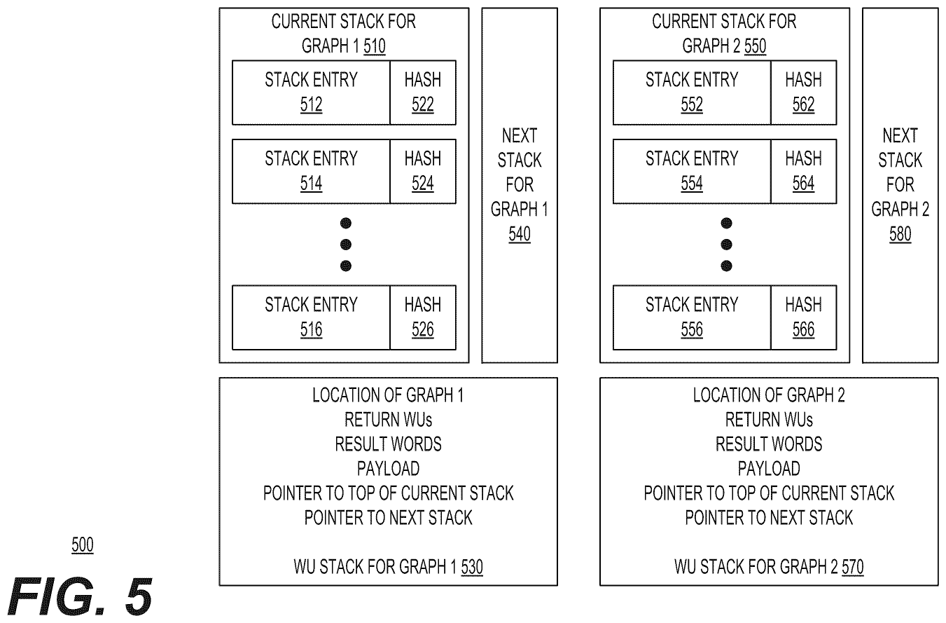

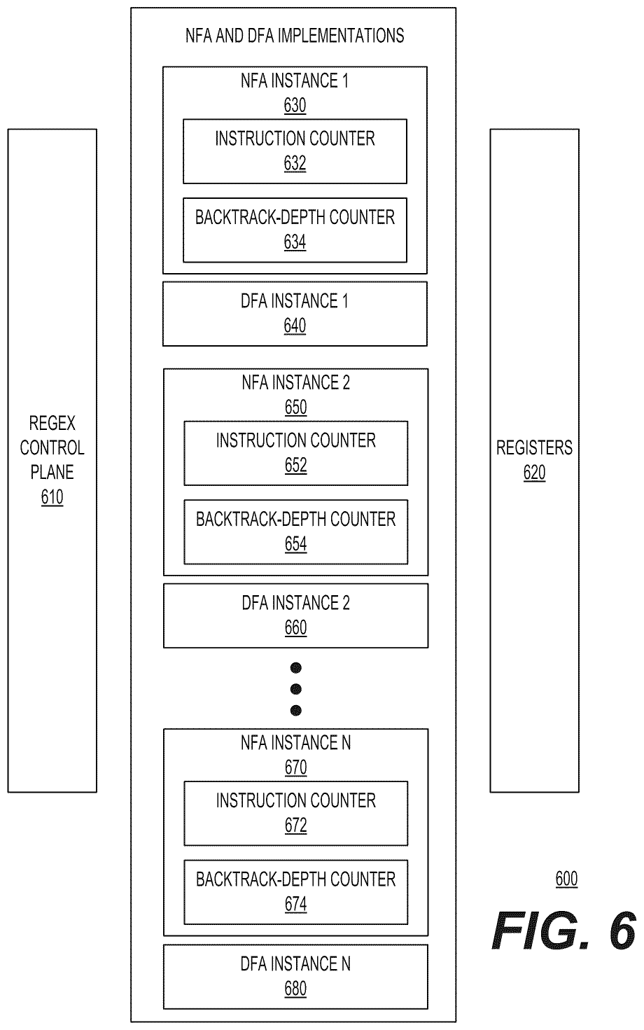

With continued reference to FIG. 3, regex accelerator 352 is configured to search through string data for virus signatures or other forms of malware. In addition, regex accelerator 352 is configured to detect any personally identifiable information (PII). As part of these analytics, the NFA instances of regex accelerator 352 can backtrack as described earlier. During regular expression processing, backtracking occurs when a regular expression pattern contains instructions that allow the NFA to return to an earlier saved state and continue matching from there. To prevent outage of the storage service offered by storage application, regex accelerator 352 implements an adaptive backtracking depth limit for each of the NFA instances. The adaptive backtracking depth limit ensures that malicious string matching does not result in a successful distributed denial-of-service (DDOS) attack against the storage service offered by storage appliance 350. Additional details of an example implementation of the adaptive backtracking depth limit for the NFAs are provided with respect to FIGS. 5 and 6.

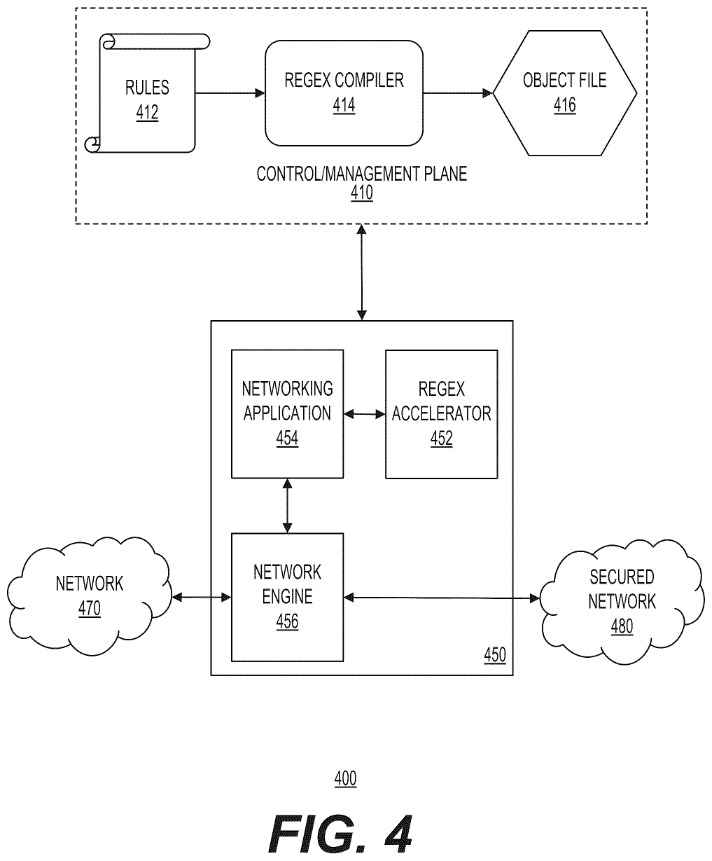

FIG. 4 is a block diagram of another regex system environment 400 with the adaptive backtracking depth limit for non-deterministic finite automatons (NFAs). Regex system environment 400 shows a control/management plane 410 coupled to a networking appliance 450, which is further coupled to a network 470 and a secured network 480. Similar to the regex system environment 300 of FIG. 3, regex system environment 400 includes a regex compiler 414 (similar to regex compiler 130 of FIG. 1), which takes rules 412 as input and generates an object file 416 as an output. Object file 416 is in a form that can be processed by regex accelerator 452. Regex accelerator 452 is configured to process NFA graphs, DFA graphs, and other software artifacts generated by regex compiler 414. Regex accelerator 452 is coupled to a networking application 454, which in turn is coupled to a network engine 456. Networking appliance 450 is coupled to a network 470 and a secured network 580. Secured network 480 is more secure because unlike network 470, the networking traffic traveling to and from secured network 480 is subjected to real-time inspection.

With continued reference to FIG. 4, regex accelerator 452 can be configured to search through real time networking traffic to perform deep packet (payload) inspection based on rules (e.g., rules 412). In addition, regex accelerator 452 can be configured as part of intrusion detection systems (IDS) and intrusion prevention systems (IPS). As part of these analytics, the NFA instances in regex accelerator 452 can backtrack as described earlier. During regular expression processing, backtracking occurs when a regular expression pattern contains instructions that allow the NFA to return to an earlier saved state and continue matching from there. To prevent outage of the storage service offered by networking appliance 450, regex accelerator 452 implements an adaptive backtracking depth limit for the NFA instances. The adaptive backtracking depth limit ensures that malicious string matching does not result in a successful distribute denial-of-service (DDOS) attack against the service offered by networking appliance 450. Additional details of an example implementation of the adaptive backtracking depth limit for the NFAs are provided with respect to FIGS. 5 and 6.

FIG. 5 shows a memory 500 associated with a regular expression accelerator (e.g., any of the regex accelerators referred to earlier) for implementing an adaptive backtracking depth limit for non-deterministic finite automatons (NFAs). Memory 500 includes stacks for the various graphs generated by a regex compiler (e.g., regex compiler 130 of FIG. 1). Memory 500 further includes information, including contextual information, for the various graphs. As an example, memory 500 is shown with a current stack for graph 1 510, a work unit (WU) stack 530, a next stack for graph 1 540, a current stack for graph 2 550, a WU stack 570, and a next stack for graph 2 580. Processing cores (or other processing elements) that are offloading work to a regex accelerator can provide such work via work queues (not shown). The regex accelerator can keep track of such requests and the processing of such requests using a WU stack.

NFA instructions generated by the regex compiler include additional information for executing these instructions using a regex accelerator. In this example, each NFA instruction includes an opcode specifying a pattern to match with the payload. In addition, each NFA instruction includes information indicative of where to go next (e.g., a jump) as well as a program counter (the next instruction to execute). Searches on the payload segment are performed by executing instructions from an NFA FSM (e.g., any of the NFA instances shown in FIG. 1) with the payload bytes as input. An instruction stack entry (e.g., anyone of the stack entries 512, 514, and 516 for current stack for graph 1 510 and anyone of stack entries 552, 554, and 556 for current stack for graph 2 550) contains the information needed to continue the execution of a partially executed instruction. As an example, the instruction stack entry includes the basic information for the instruction itself and additional execution context. As shown in FIG. 5, a hash value, which is computed over immutable information in the stack entry corresponding to each stack entry, is also stored as part of the current stack for each NFA graph. As an example, FIG. 5 shows hash values 522, 524, and 526 corresponding to the stack entries in the current stack for graph 1 510. In addition, FIG. 5 shows hash values 562, 564, and 566 corresponding to the stack entries in the current stack for graph 2 550. Although FIG. 5 shows memory 500 including certain information organized in a certain manner, memory 500 may contain additional or less information that is organized differently.

FIG. 6 shows a regular expression (regex) accelerator 600 for implementing an adaptive backtracking depth limit for non-deterministic finite automatons (NFAs). Regex accelerator 600 can access the contents of memory 500 via load/store instructions or other types of memory instructions depending on the type of memory. Additional external memory (not shown) can be coupled to memory 500 for providing storage for additional data or control information. In this example, regex accelerator 600 includes a regex control plane 610, registers 620, and NFA and DFA implementations. In this example, regex accelerator 600 is shown with an N number of DFA instances (e.g., DFA instance 1 640, DFA instance 2 660, and DFA instance N 680) and the same number of NFA instances (e.g., NFA instance 1 630, NFA instance 2 650, and NFA instance N 670). Each NFA instance also includes a corresponding instruction counter and a backtrack-depth counter. As an example, NFA instance 1 630 includes instruction counter 632 and backtrack-depth counter 634, NFA instance 2 650 includes instruction counter 652 and backtrack-depth counter 654, and NFA instance N 670 includes instruction counter 672 and backtrack-depth counter 674. Registers 620 can be used to store various pieces of information required for execution and backtracking.

With continued reference to FIG. 6, the NFA instance (e.g., any of NFA instance 1 630, NFA instance 2 650, or NFA instance N 670) starts processing a respective payload by popping a current instruction stack entry to “continue” its execution. An entry is pushed onto the current instruction stack when one of the multiple paths in an instruction is taken. Before pushing the entry, the hash of the “to-be-pushed” entry is compared with the hash values of the previously pushed entries to check if the entry being pushed represents the same execution state as that of a previously pushed entry. A corresponding backtrack-depth counter (e.g., any of the respective backtrack-depth counters shown in FIG. 6) is incremented when the entry is found matching with any previously pushed entries. This incrementing of the backtrack-depth counter allows the NFA instance to keep a record of the number of times backtracking has occurred during a match attempt. The backtrack-depth counter can have a configurable threshold to stop pushing the same state for the current match attempt.

Still referring to FIG. 6, result words are written back by the regex control plane 610 to the appropriate WU stack (e.g., WU stack for graph 1 530 or WU stack for graph 2 570 of FIG. 5) with information, including information regarding whether the backtrack-depth counter met the adaptive backtracking depth limit. An entry is pushed onto the next instruction stack when the end of the payload is reached during processing any instruction. Finally, the next instruction stack is returned by the NFA instance to the application that offloaded the processing to the regex accelerator. In this example, an NFA instruction counter will be incremented for each instruction on a per match attempt basis. Upon reaching the backtracking depth limit, the application that offloaded the processing to the regex accelerator is notified either by an interrupt or a flag in the result word entry in the WU stack (e.g., WU stack for graph 1 530 or WU stack for graph 2 570 of FIG. 5) for the NFA graph. Although FIG. 6 shows regex accelerator 600 having certain components that are arranged in a certain manner, regex accelerator 600 can have fewer or more components that are arranged differently.

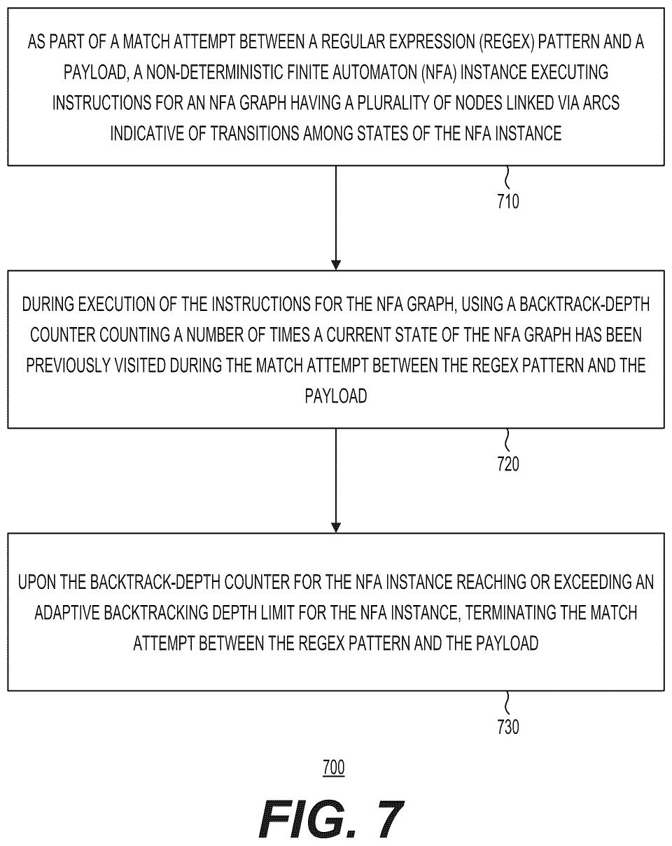

FIG. 7 is a flow diagram 700 of a method for implementing the adaptive backtracking depth limit for non-deterministic finite automatons (NFAs) in accordance with one example. Step 710 includes as part of a match attempt between a regular expression (regex) pattern and a payload, a non-deterministic finite automaton (NFA) instance executing instructions for an NFA graph having a plurality of nodes linked via arcs indicative of transitions among states of the NFA instance. Any of the NFA instances described earlier with respect to FIG. 6 can be an instance that is performing this step in the manner described earlier.

Step 720 includes during execution of the instructions for the NFA graph, using a backtrack-depth counter counting a number of times a current state of the NFA graph has been previously visited during the match attempt between the regex pattern and the payload. As part of this step, in one example, any of the NFA instances described earlier with respect to FIG. 6 can use a corresponding backtrack-depth counter (e.g., any backtrack-depth counters 634, 654, and 674).

Step 730 includes upon the backtrack-depth counter for the NFA instance reaching or exceeding an adaptive backtracking depth limit for the NFA instance, terminating the match attempt between the regex pattern and the payload. As described earlier with respect to FIGS. 5 and 6, each NFA instance has access to a memory (e.g., memory 500 of FIG. 6) that includes the current stack for each of the NFA graphs being processed. In addition, as described earlier, the NFA instance (e.g., any of NFA instance 1 to N shown in FIG. 6) starts processing a respective payload by popping a current instruction stack entry to “continue” its execution. An entry is pushed onto the current instruction stack when one of the multiple paths in an instruction is taken. Before pushing the entry, the hash of the “to-be-pushed” entry is compared with the hash values of the previously pushed entries to check if the entry being pushed represents the same execution state as that of a previously pushed entry. A corresponding backtrack-depth counter (e.g., any of a respective backtrack-depth counters shown in FIG. 6) is incremented when the entry is found matching with any previously pushed entries. This incrementing of the backtrack-depth counter allows the NFA instance to keep a record of the number of times backtracking has occurred during a match attempt. Although FIG. 7 describes several steps performed in a certain order, additional or fewer steps may be performed in a different order.

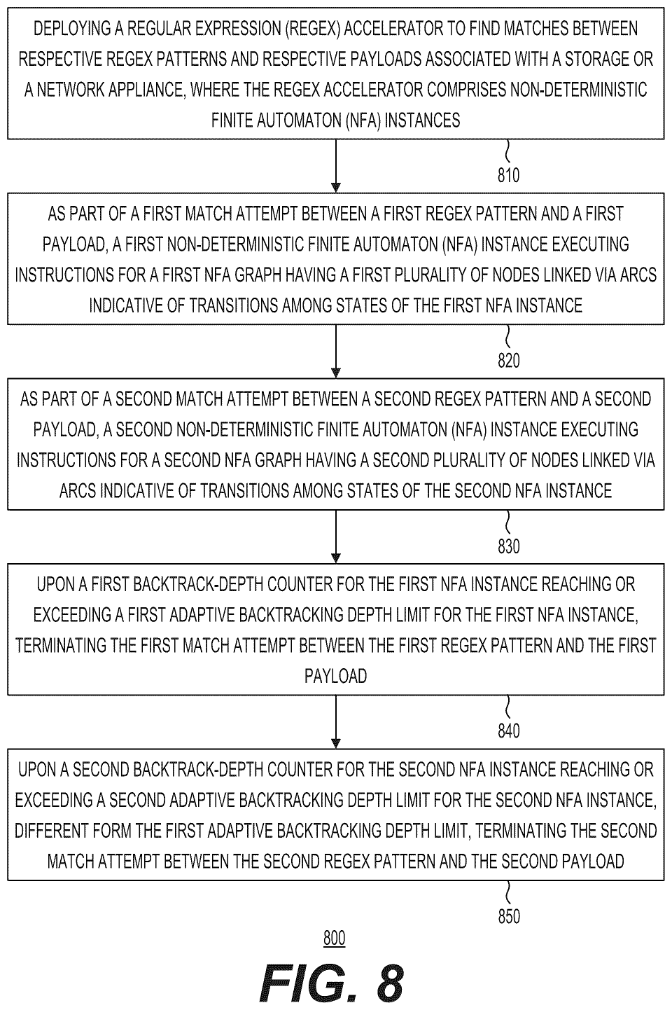

FIG. 8 is a flow diagram 800 of a method for implementing the adaptive backtracking depth limit for non-deterministic finite automatons (NFAs) in accordance with one example. Step 810 includes deploying a regular expression (regex) accelerator to find matches between respective regex patterns and respective payloads associated with a storage or a network appliance, where the regex accelerators comprises non-deterministic finite automaton (NFA) instances. As an example, FIG. 3 shows a deployment with a storage appliance and FIG. 4 shows a deployment with a network appliance.

Step 820 includes as part of a first match attempt between a first regex pattern and a first payload, a first non-deterministic finite automaton (NFA) instance executing instructions for a first NFA graph having a first plurality of nodes linked via arcs indicative of transitions among states of the first NFA instance. Any of the NFA instances described earlier with respect to FIG. 6 can perform this step.

Step 830 includes as part of a second match attempt between a second regex pattern and a second payload, a second non-deterministic finite automaton (NFA) instance executing instructions for a second NFA graph having a second plurality of nodes linked via arcs indicative of transitions among states of the second NFA instance. Any of another one of the NFA instances described earlier with respect to FIG. 6 can perform this step.

Step 840 includes upon a first backtrack-depth counter for the first NFA instance reaching or exceeding a first adaptive backtracking depth limit for the first NFA instance, terminating the first match attempt between the first regex pattern and the first payload. As described earlier with respect to FIGS. 5 and 6, each NFA instance has access to a memory (e.g., memory 500 of FIG. 6) that includes the current stack for each of the NFA graphs being processed. In addition, as described earlier, the NFA instance (e.g., any of NFA instance 1 to N shown in FIG. 6) starts processing a respective payload by popping a current instruction stack entry to “continue” its execution. An entry is pushed onto the current instruction stack when one of the multiple paths in an instruction is taken. Before pushing the entry, the hash of the “to-be-pushed” entry is compared with the hash values of the previously pushed entries to check if the entry being pushed represents the same execution state as that of a previously pushed entry. A corresponding backtrack-depth counter (e.g., any of the respective backtrack-depth counters shown in FIG. 6) is incremented when the entry is found matching with any previously pushed entries. This incrementing of the first backtrack-depth counter allows the first NFA instance to keep a record of the number of times backtracking has occurred during the first match attempt.

Step 850 includes upon a second backtrack-depth counter for the second NFA instance reaching or exceeding a second adaptive backtracking depth limit for the second NFA instance, different form the first adaptive backtracking depth limit, terminating the second match attempt between the second regex pattern and the second payload. As described earlier with respect to FIGS. 5 and 6, each NFA instance has access to a memory (e.g., memory 500 of FIG. 6) that includes the current stack for each of the NFA graphs being processed. In addition, as described earlier, the NFA instance (e.g., any of NFA instance 1 to N shown in FIG. 6) starts processing a respective payload by popping a current instruction stack entry to “continue” its execution. An entry is pushed onto the current instruction stack when one of the multiple paths in an instruction is taken. Before pushing the entry, the hash of the “to-be-pushed” entry is compared with the hash values of the previously pushed entries to check if the entry being pushed represents the same execution state as that of a previously pushed entry. A corresponding backtrack-depth counter (e.g., any of the respective backtrack-depth counters shown in FIG. 6) is incremented when the entry is found matching with any previously pushed entries. This incrementing of the second backtrack-depth counter allows the second NFA instance to keep a record of the number of times backtracking has occurred during the second match attempt. Although FIG. 8 describes several steps performed in a certain order, additional or fewer steps may be performed in a different order.

In conclusion, the present disclosure relates to a method including, as part of a match attempt between a regular expression (regex) pattern and a payload, a non-deterministic finite automaton (NFA) instance executing instructions for an NFA graph having a plurality of nodes linked via arcs indicative of transitions among states of the NFA instance. The method may further include during execution of the instructions for the NFA graph, using a backtrack-depth counter counting a number of times a current state of the NFA graph has been previously visited during the match attempt between the regex pattern and the payload. The method may further include, upon the backtrack-depth counter for the NFA instance reaching or exceeding an adaptive backtracking depth limit for the NFA instance, terminating the match attempt between the regex pattern and the payload.

The method may further include: (1) during backtracking storing intermediate matches between the regex pattern and the payload, and (2) during a second match attempt, subsequent to a termination of the match attempt, backtracking only to a previous successful partial match between the regex pattern and the payload. The method may further include: (1) using a first instruction counter tracking a first number of the instructions executed by the NFA instance prior to a successful match between the regex pattern and the payload, (2) using a second instruction counter tracking a second number of instructions executed by the NFA instance prior to termination of the match attempt between the regex pattern and the payload.

The method may further include for each successful match attempt or a failed match attempt between a regex pattern and a payload storing a result. The method may further include maintaining in a memory associated with the NFA instance: (1) stack entries for instructions being executed for the NFA graph and (2) a hash value for each of the stack entries. Counting the number of times the current state of the NFA graph has been previously visited during the match attempt between the regex pattern and the payload may comprise counting a number of matches between a hash value for a given stack entry and any hash values of stack entries previously pushed to a top of a stack for instructions being executed by the NFA instance.

In another example, the present disclosure relates to a method including, as part of a match attempt between a regular expression (regex) pattern and a payload, a non-deterministic finite automaton (NFA) instance executing instructions for an NFA graph having a plurality of nodes linked via arcs indicative of transitions among states of the NFA instance. The method may further include during execution of the instructions for the NFA graph, using a backtrack-depth counter counting a number of times a current state of the NFA graph has been previously visited during the match attempt between the regex pattern and the payload.

The method may further include, upon the backtrack-depth counter for the NFA instance reaching or exceeding an adaptive backtracking depth limit for the NFA instance, terminating the match attempt between the regex pattern and the payload. The method may further include dynamically adjusting the adaptive backtracking depth limit for the NFA instance depending on an input size of the payload.

The method may further include: (1) during backtracking storing intermediate matches between the regex pattern and the payload, and (2) during a second match attempt, subsequent to a termination of the match attempt, backtracking only to a previous successful partial match between the regex pattern and the payload. The method may further include: (1) using a first instruction counter tracking a first number of the instructions executed by the NFA instance prior to a successful match between the regex pattern and the payload, (2) using a second instruction counter tracking a second number of instructions executed by the NFA instance prior to termination of the match attempt between the regex pattern and the payload.

The method may further include for each successful match attempt or a failed match attempt between a regex pattern and a payload storing a result. Dynamically adjusting the adaptive backtracking depth limit for the NFA instance may comprise allowing for more backtracking for a payload with a smaller size relative to a payload with a larger size.

The method may further include maintaining in a memory associated with the NFA instance: (1) stack entries for instructions being executed for the NFA graph and (2) a hash value for each of the stack entries. Counting the number of times the current state of the NFA graph has been previously visited during the match attempt between the regex pattern and the payload may comprise counting a number of matches between a hash value for a given stack entry and any hash values of stack entries previously pushed to a top of a stack for instructions being executed by the NFA instance.

In a yet another example, the present disclosure relates to a method including deploying a regular expression (regex) accelerator to find matches between respective regex patterns and respective payloads associated with a storage or a network appliance, where the regex accelerator comprises non-deterministic finite automaton (NFA) instances. The method may further include as part of a first match attempt between a first regex pattern and a first payload, a first non-deterministic finite automaton (NFA) instance executing instructions for a first NFA graph having a first plurality of nodes linked via arcs indicative of transitions among states of the first NFA instance. The method may further include as part of a second match attempt between a second regex pattern and a second payload, a second non-deterministic finite automaton (NFA) instance executing instructions for a second NFA graph having a second plurality of nodes linked via arcs indicative of transitions among states of the second NFA instance.

The method may further include upon a first backtrack-depth counter for the first NFA instance reaching or exceeding a first adaptive backtracking depth limit for the first NFA instance, terminating the first match attempt between the first regex pattern and the first payload. The method may further include upon a second backtrack-depth counter for the second NFA instance reaching or exceeding a second adaptive backtracking depth limit for the second NFA instance, different form the first adaptive backtracking depth limit, terminating the second match attempt between the second regex pattern and the second payload.

The method may further include controlling backtracking to prevent a service outage associated with a service offered by either the storage or the network appliance. The method may further include dynamically adjusting the first adaptive backtracking depth limit for the first NFA instance depending on an input size of the first payload. The method may further include dynamically adjusting the second adaptive backtracking depth limit for the second NFA instance depending on an input size of the second payload. Dynamically adjusting the first adaptive backtracking depth limit for the first NFA instance or the second adaptive backtracking depth limit for the second NFA instance may comprise allowing for more backtracking for a payload with a smaller size relative to a payload with a larger size.

The method may further comprise for each successful match attempt or a failed match attempt between a regex pattern and a payload storing a result. The method may further include: (1) during execution of the instructions for the first NFA graph, using the first backtrack-depth counter counting a first number of times a current state of the first NFA graph has been previously visited during the first match attempt between the first regex pattern and the first payload, and (2) during execution of the instructions for the second NFA graph, using the second backtrack-depth counter counting a second number of times a current state of the second NFA graph has been previously visited during the second match attempt between the second regex pattern and the second payload.

It is to be understood that the methods, modules, and components depicted herein are merely exemplary. Alternatively, or in addition, the functionally described herein can be performed, at least in part, by one or more hardware logic components. For example, and without limitation, illustrative types of hardware logic components that can be used include Field-Programmable Gate Arrays (FPGAs), Application-Specific Integrated Circuits (ASICs), Application-Specific Standard Products (ASSPs), System-on-a-Chip systems (SOCs), or Complex Programmable Logic Devices (CPLDs). In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or inter-medial components. Likewise, any two components so associated can also be viewed as being “operably connected,” or “coupled,” to each other to achieve the desired functionality.

The functionality associated with some examples described in this disclosure can also include instructions stored in a non-transitory media. The term “non-transitory media” as used herein refers to any media storing data and/or instructions that cause a machine to operate in a specific manner. Exemplary non-transitory media include non-volatile media and/or volatile media. Non-volatile media include, for example, a hard disk, a solid state drive, a magnetic disk or tape, an optical disk or tape, a flash memory, an EPROM, NVRAM, PRAM, or other such media, or networked versions of such media. Volatile media include, for example, dynamic memory, such as, DRAM, SRAM, a cache, or other such media. Non-transitory media is distinct from, but can be used in conjunction with transmission media. Transmission media is used for transferring data and/or instruction to or from a machine. Exemplary transmission media, include coaxial cables, fiber-optic cables, copper wires, and wireless media, such as radio waves.

Furthermore, those skilled in the art will recognize that boundaries between the functionality of the above described operations are merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

Although the disclosure provides specific examples, various modifications and changes can be made without departing from the scope of the disclosure as set forth in the claims below. Accordingly, the specification and figures are to be regarded in an illustrative rather than a restrictive sense, and all such modifications are intended to be included within the scope of the present disclosure. Any benefits, advantages, or solutions to problems that are described herein with regard to a specific example are not intended to be construed as a critical, required, or essential feature or element of any or all the claims.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

1. A method comprising:
as part of a match attempt between a regular expression (regex) pattern and a payload, a non-deterministic finite automaton (NFA) instance executing instructions for an NFA graph having a plurality of nodes linked via arcs indicative of transitions among states of the NFA instance;
during execution of the instructions for the NFA graph, using a backtrack-depth counter counting a number of times a current state of the NFA graph has been previously visited during the match attempt between the regex pattern and the payload; and
upon the backtrack-depth counter for the NFA instance reaching or exceeding an adaptive backtracking depth limit for the NFA instance, terminating the match attempt between the regex pattern and the payload.

2. The method of claim 1, further comprising: (1) during backtracking storing intermediate matches between the regex pattern and the payload, and (2) during a second match attempt, subsequent to a termination of the match attempt, backtracking only to a previous successful partial match between the regex pattern and the payload.

3. The method of claim 1, further comprising: (1) using a first instruction counter tracking a first number of the instructions executed by the NFA instance prior to a successful match between the regex pattern and the payload, (2) using a second instruction counter tracking a second number of instructions executed by the NFA instance prior to termination of the match attempt between the regex pattern and the payload.

4. The method of claim 1, further comprising for each successful match attempt or a failed match attempt between a regex pattern and a payload storing a result.

5. The method of claim 1, further comprising maintaining in a memory associated with the NFA instance: (1) stack entries for instructions being executed for the NFA graph and (2) a hash value for each of the stack entries.

6. The method of claim 5, wherein counting the number of times the current state of the NFA graph has been previously visited during the match attempt between the regex pattern and the payload comprises counting a number of matches between a hash value for a given stack entry and any hash values of stack entries previously pushed to a top of a stack for instructions being executed by the NFA instance.

7. A method comprising:
as part of a match attempt between a regular expression (regex) pattern and a payload, a non-deterministic finite automaton (NFA) instance executing instructions for an NFA graph having a plurality of nodes linked via arcs indicative of transitions among states of the NFA instance;
during execution of the instructions for the NFA graph, using a backtrack-depth counter counting a number of times a current state of the NFA graph has been previously visited during the match attempt between the regex pattern and the payload;
upon the backtrack-depth counter for the NFA instance reaching or exceeding an adaptive backtracking depth limit for the NFA instance, terminating the match attempt between the regex pattern and the payload; and
dynamically adjusting the adaptive backtracking depth limit for the NFA instance depending on an input size of the payload.

8. The method of claim 7, further comprising: (1) during backtracking storing intermediate matches between the regex pattern and the payload, and (2) during a second match attempt, subsequent to a termination of the match attempt, backtracking only to a previous successful partial match between the regex pattern and the payload.

9. The method of claim 7, further comprising: (1) using a first instruction counter tracking a first number of the instructions executed by the NFA instance prior to a successful match between the regex pattern and the payload, (2) using a second instruction counter tracking a second number of instructions executed by the NFA instance prior to termination of the match attempt between the regex pattern and the payload.

10. The method of claim 7, further comprising for each successful match attempt or a failed match attempt between a regex pattern and a payload storing a result.

11. The method of claim 7, wherein dynamically adjusting the adaptive backtracking depth limit for the NFA instance comprises allowing for more backtracking for a payload with a smaller size relative to a payload with a larger size.

12. The method of claim 7, further comprising maintaining in a memory associated with the NFA instance: (1) stack entries for instructions being executed for the NFA graph and (2) a hash value for each of the stack entries.

13. The method of claim 12, wherein counting the number of times the current state of the NFA graph has been previously visited during the match attempt between the regex pattern and the payload comprises counting a number of matches between a hash value for a given stack entry and any hash values of stack entries previously pushed to a top of a stack for instructions being executed by the NFA instance.

14. A method comprising:
deploying a regular expression (regex) accelerator to find matches between respective regex patterns and respective payloads associated with a storage or a network appliance, wherein the regex accelerator comprises non-deterministic finite automaton (NFA) instances;
as part of a first match attempt between a first regex pattern and a first payload, a first non-deterministic finite automaton (NFA) instance executing instructions for a first NFA graph having a first plurality of nodes linked via arcs indicative of transitions among states of the first NFA instance;
as part of a second match attempt between a second regex pattern and a second payload, a second non-deterministic finite automaton (NFA) instance executing instructions for a second NFA graph having a second plurality of nodes linked via arcs indicative of transitions among states of the second NFA instance;
upon a first backtrack-depth counter for the first NFA instance reaching or exceeding a first adaptive backtracking depth limit for the first NFA instance, terminating the first match attempt between the first regex pattern and the first payload; and
upon a second backtrack-depth counter for the second NFA instance reaching or exceeding a second adaptive backtracking depth limit for the second NFA instance, different form the first adaptive backtracking depth limit, terminating the second match attempt between the second regex pattern and the second payload.

15. The method of claim 14, further comprising controlling backtracking to prevent a service outage associated with a service offered by either the storage or the network appliance.

16. The method of claim 14, further comprising dynamically adjusting the first adaptive backtracking depth limit for the first NFA instance depending on an input size of the first payload.

17. The method of claim 16, further comprising dynamically adjusting the second adaptive backtracking depth limit for the second NFA instance depending on an input size of the second payload.

18. The method of claim 17, wherein dynamically adjusting the first adaptive backtracking depth limit for the first NFA instance or the second adaptive backtracking depth limit for the second NFA instance comprises allowing for more backtracking for a payload with a smaller size relative to a payload with a larger size.

19. The method of claim 14, further comprising for each successful match attempt or a failed match attempt between a regex pattern and a payload storing a result.

20. The method of claim 14, further comprising: (1) during execution of the instructions for the first NFA graph, using the first backtrack-depth counter counting a first number of times a current state of the first NFA graph has been previously visited during the first match attempt between the first regex pattern and the first payload, and (2) during execution of the instructions for the second NFA graph, using the second backtrack-depth counter counting a second number of times a current state of the second NFA graph has been previously visited during the second match attempt between the second regex pattern and the second payload.
